(19) United States
(12) Patent Application Publication
(10) Pub. No.: US 2025/0145913 A1
(43) Pub. Date: May 8, 2025

(54) DETERGENT COMPOSITIONS CONTAINING FERMENTED AMINO ACIDS AND MAILLARD REACTION INHIBITING ENZYMES

(71) Applicant: Henkel AG & Co. KGaA, Duesseldorf (DE)

(72) Inventor: Daniel Thomas Piorkowski, Fairfield, CT (US)

(21) Appl. No.: 18/926,821

(22) Filed: Oct. 25, 2024

Related U.S. Application Data
(60) Provisional application No. 63/547,703, filed on Nov. 8, 2023.

(51) Int. Cl. C11D 3/386; C11D 3/22; C11D 3/30; C11D 3/33; C11D 3/43; C11D 17/04

(52) U.S. Cl. CPC C11D 3/38636; C11D 3/221; C11D 3/222; C11D 3/30; C11D 3/33; C11D 3/43; C11D 17/043

(57) ABSTRACT

A detergent composition useful for laundry applications in both unit dose form and non-unit dose form is provided. The detergent composition includes a primary amine source of a fermented amino acid including a reducing sugar and a Maillard reaction inhibiting enzyme that inhibits the reducing sugar from reacting with the primary amine source. The detergent composition which includes the enzyme does not undergo yellowing and thus has an increased shelf-life compared to an equivalent laundry detergent composition that lacks such an enzyme.

### CROSS REFERENCE TO RELATED APPLICATION

This application claims benefit of priority to U.S. Provisional Application Ser. No. 63/547,703 filed Nov. 8, 2023, the entire content of which is incorporated herein by reference.

### BACKGROUND

The present disclosure relates to detergents, and more particularly to a laundry detergent composition in unit dose form and non-unit dose form having an increased shelf-life.

In laundry detergent compositions in both unit dose form and non-unit dose form, there is an ongoing trend to include sustainable materials in formulating the detergent composition. Sustainable materials are derived from renewable, recycled and waste carbon sources and their combination, which at the end of life can be recycled, biodegraded, or composted. Sustainable materials also exhibit reduced environmental impact throughout their life cycle. The use of sustainable materials within laundry detergent compositions can reduce the cost of formulating the detergent composition and can provide an environmentally friendly product.

In some instances, the sustainable material (i.e., raw material) used in formulating the detergent composition includes a reducing sugar, such as, for example, fructose or glucose. The reducing sugar can be a contaminant (i.e., residual) in the sustainable material or it can be part (i.e., a moiety) of the sustainable material, for example, a monomer of a polymer, which degrades from the sustainable material over time.

Reducing sugars undergo a Maillard reaction and cause browning in products when in the presence of an amine and heat. In laundry detergents, amines can be from monoethanolamine (which is used as a neutralizer), amino acids or enzymes (e.g., proteins). Browning reactions cause detergent compositions to turn yellow over time, especially when stored at elevated temperatures such as, for example, from 35° C. to 50° C. In some cases, it has been observed that as little as 40 ppm of reducing sugars can cause browning reactions to occur within the detergent composition over time.

The discoloration, i.e., yellowing, of the detergent composition caused by the Maillard reaction can lead to consumer dissatisfaction and consumer apprehension that the detergent composition is no longer useable. Thus, there is a need for providing non-yellowing detergent compositions in both unit dose form and non-unit dose form.

### SUMMARY

A detergent composition useful for laundry applications in both unit dose form and non-unit dose form is provided. The detergent composition of the present disclosure includes (i) a primary amine source comprising a fermented amino acid including a reducing sugar; and (ii) an enzyme that inhibits the reducing sugar from reacting with this primary amine source. In the present disclosure, the fermented amino acid is a sustainable material that is used in formulating the detergent composition. The enzyme prevents a Maillard reaction from occurring and thus is referred to herein as a “Maillard reaction inhibiting enzyme”. In the present disclosure a Maillard reaction is a chemical reaction between an amino acid and a reducing sugar, which can create melanoidins. Melanoidins are brown, high molecular weight heterogeneous polymers that are formed when sugars and amino acids combine through the Maillard reaction. The formation of such polymers can cause browning to occur within a laundry detergent. In the present disclosure, the Maillard reaction can further include the reaction of other amine sources as defined herein including, for example, monoethanolamine with reducing sugars to produce other brown-colored chemistries. The detergent composition of the present disclosure which includes the Maillard reaction inhibiting enzyme does not undergo yellowing and thus has an increased shelf-life compared to an equivalent laundry detergent composition that lacks such an enzyme. Since yellowing is prevented, consumer confidence in the detergent composition of the present disclosure would be improved.

In one aspect of the present disclosure, a detergent product is provided. In the present disclosure, the detergent product represents a unit dose embodiment. In one embodiment, the detergent product comprises a container made by a water-soluble or water-dispersible film, and a detergent composition encapsulated in the container. In the present disclosure, the container can be a pouch, a pod or a pack (or pac). In some embodiments, the detergent composition that is encapsulated in the container comprises at least one surfactant, a primary amine source comprising a fermented amino acid including a reducing sugar, a Maillard reaction inhibiting enzyme that inhibits reaction between the primary amine source and the reducing sugar, and water. In the unit dose embodiment, water is present in the composition in an amount from about 5 percent to about 45 percent.

In the present disclosure, the reducing sugar can be a residual contaminant present in the fermented amino acid, or it can be a moiety of the fermented amino acid that can be released upon degradation. Degradation of the reducing sugar can occur during formulation and storage, especially when the detergent composition is stored at elevated temperatures.

In other embodiments, the detergent composition that is encapsulated in the container consists essentially of at least one surfactant, a primary amine source comprising a fermented amino acid including a reducing sugar, a Maillard reaction inhibiting enzyme that inhibits reaction between the primary amine source and the reducing sugar, and water.

In yet further embodiments, the detergent composition that is encapsulated in the container consists of at least one surfactant, a primary amine source comprising a fermented amino acid including a reducing sugar, a Maillard reaction inhibiting enzyme that inhibits reaction between the primary amine source and the reducing sugar, and water.

In another aspect of the present disclosure, a liquid detergent composition is provided. In the present disclosure, the liquid detergent composition represents a non-unit dose embodiment. In one embodiment, the liquid detergent composition comprises at least one surfactant, a primary amine source comprising a fermented amino acid including a reducing sugar, a Maillard reaction inhibiting enzyme that inhibits reaction between the primary amine source and the reducing sugar, and water. In this embodiment, water is present in the liquid detergent composition in an amount from about 20 percent to about 95 percent.

In some embodiments, the liquid detergent composition consists essentially of at least one surfactant, a primary amine source comprising a fermented amino acid including a reducing sugar, a Maillard reaction inhibiting enzyme that inhibits reaction between the primary amine source and the reducing sugar, and water.

In yet further embodiments, the liquid detergent composition consists of at least one surfactant, a primary amine source comprising a fermented amino acid including a reducing sugar, a Maillard reaction inhibiting enzyme that inhibits reaction between the primary amine source and the reducing sugar, and water.

In both the unit dose and non-unit dose embodiments, a secondary amine source can be optionally present. When present, the secondary amine source can include an ethanolamine compound, a chelating agent, another amino acid, an amine containing enzyme or combinations thereof. The Maillard reaction inhibiting enzyme will inhibit the reducing sugar from reacting with both the primary amine source and, if present, the secondary amine source.

In both the unit dose and non-unit dose embodiments, the fermented amino acid can include alanine, arginine, asparagine, aspartate, cysteine, glutamine, glutamate, glycine, histidine, isoleucine, lysine, methionine, phenylalanine, proline, serine, threonine, tryptophan, tyrosine, valine, or any combination thereof. In one preferred embodiment, the primary amine source is lysine. The fermented amino acid can be in any stereoisomeric configuration, e.g., L-lysine or D-lysine can be used.

In both the unit dose and non-unit dose embodiments, the reducing sugar can include fructose, glucose, hexose, lactose, glyceraldehyde, arabinose, maltose, galactose, ribose, xylose, cellobiose or combinations thereof.

In both the unit dose and non-unit dose embodiments, the Maillard reaction inhibiting enzyme can include fructosamine oxidase, fructosamine kinase, carbohydrate oxidase or combinations thereof.

In both the unit dose and non-unit dose embodiments, the Maillard reaction inhibiting enzyme is typically present in the detergent composition in an amount of from about 0.001 weight percent to about 3 weight percent.

In both the unit dose and non-unit dose embodiments, the sustainable polymer is typically present in the detergent composition in an amount of from about 0.01 weight percent to about 10 weight percent.

In both the unit dose and non-unit dose embodiments, the detergent composition can further include a sustainable solvent including a reducing sugar, a sustainable polymer containing a reducing sugar monomer or a combination thereof (i.e., a combination of a sustainable polymer and a sustainable solvent with their respective reducing sugars). In the present disclosure, the reducing sugar of the sustainable solvent can be a residual contaminant present in the sustainable solvent, or it can be a moiety of the sustainable solvent that can be released upon degradation. In embodiments in which the sustainable solvent is present, the sustainable solvent is typically present in the detergent composition in an amount from 0.01 weight percent to about 60 weight percent. When present, the sustainable solvent can include sorbitol, xylitol, mannitol, lactitol, isomalt, maltitol, a hydrogenated starch hydrolysate, sucrose, stachyose, verbascose, trehalose, raffinose or combinations thereof.

In the present disclosure, the reducing sugar monomer of the sustainable polymer can be a residual contaminant present in the sustainable polymer, or it can be a moiety of the sustainable polymer that can be released upon degradation. In embodiments in which the sustainable polymer is present, the sustainable polymer is typically present in the detergent composition in an amount from 0.01 weight percent to about 10 weight percent. When present, the sustainable polymer can include a starch, a glycogen, a galactogen, a cellulose, a chitin or mixtures thereof.

In embodiments in which at least one of a sustainable solvent and the sustainable polymer is present, the Maillard reaction inhibiting enzyme can also inhibit the reaction between the reducing sugars with the primary amine source (i.e., the fermented amino acid) and, if present, the secondary amine source and the reducing sugars associated with the sustainable solvent and/or the sustainable polymer.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than +10%, +5%, +2%, +1% or +0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

As stated above, a detergent composition useful for laundry applications in both unit dose form and non-unit dose form is provided that has an increased shelf-life. The detergent composition of the present disclosure includes at least one surfactant, a primary amine source of a fermented amino acid including a reducing sugar that can react with the reducing sugar of the primary amine source, a Maillard reaction inhibiting enzyme that inhibits reaction between the primary amine source and the reducing sugar, and water. In embodiments of the present application, the detergent composition of the present disclosure can also include a secondary amine source that can also react with the reducing sugar. In such an embodiment, the Maillard reaction inhibiting enzyme can inhibit reaction between the reducing sugar and both the primary and secondary amine sources.

As mentioned previously in this disclosure, the presence of such an enzyme inhibits the Maillard reaction between the reducing sugar and the primary amine source (and if present, the secondary amine source) and thus the detergent composition of the present disclosure in both unit dose form and non-unit dose form has an increased shelf-life. The increased shelf-life is evidenced by the absence of yellowing of the detergent composition of the present disclosure over an extended period of time. In the present disclosure, the enzyme inhibits the reaction of the reducing sugar with the amine source (primary and, if present, secondary) throughout the entire shelf-life of the detergent composition including at the beginning of the formulation process. These and other aspects of the present disclosure will now be described in greater detail.

As stated above, the detergent composition of the present disclosure used in unit dose form or non-unit dose form includes at least one surfactant. The at least one surfactant is typically present in the detergent composition in an amount from about 5 weight percent to about 70 weight percent, with an amount from about 15 weight percent to about 65 weight percent being more typically, and with an amount from about 20 weight percent to about 50 weight percent being more typical. In the present disclosure, all weight percents are based on the total weight of the detergent composition unless otherwise specified.

The at least one surfactant can include an anionic surfactant, a non-ionic surfactant, a cationic surfactant, a semi-polar surfactant, a zwitterionic surfactant or combinations thereof. In some embodiments, the at least one surfactant includes one or more anionic surfactants and one or more non-anionic surfactants. In embodiments in which two or more surfactants are employed, the combination of surfactants can be referred to as a surfactant system.

In some embodiments, the at least one surfactant is an anionic surfactant. When an anionic surfactant is present, the anionic surfactant is typically present in the detergent composition in an amount from about 2 weight percent to about 35 weight percent, with an amount from amount from about 8 weight percent to about 25 weight percent being more typical, and an amount from about 15 weight percent to about 20 weight percent being even more typical. Non-limiting examples of anionic surfactants that can be employed in the present disclosure include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diyIbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), or combinations thereof.

In some embodiments, the at least one surfactant is a nonionic surfactant. When a nonionic surfactant is present, the nonionic surfactant is typically present in the detergent composition in an amount from about 2 weight percent to about 30 weight percent, with an amount from amount from about weight percent to about 25 weight percent being more typical, and an amount from about 15 weight percent to about 20 weight percent being even more typical. Non-limiting examples of nonionic surfactants that can be employed in the present disclosure include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA).

In some embodiments, the least one surfactant is a cationic surfactant. When a cationic surfactant is present, the cationic surfactant is typically present in the detergent composition in an amount from about 2 weight percent to about 35 weight percent, with an amount from amount from about 8 weight percent to about 25 weight percent being more typical, and an amount from about 15 weight percent to about 20 weight percent being even more typical. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, or combinations thereof.

In some embodiments, the detergent composition of the present disclosure can include at least one semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, or combinations thereof. In some embodiments, the detergent composition of the present disclosure can include at least one zwitterionic surfactant. Non-limiting examples of zwitterionic surfactants that can be employed include betaines such as alkyldimethylbetaines, sulfobetaines, or combinations thereof. When a semipolar surfactant and/or a zwitterionic surfactant are present, each of the semipolar surfactant and/or the zwitterionic surfactant is typically present in the detergent composition in an amount from about 2 weight percent to about 35 weight percent, with an amount from amount from about 8 weight percent to about 25 weight percent being more typical, and an amount from about 15 weight percent to about 20 weight percent being even more typical.

In some embodiments, the at least one surfactant is a surfactant system that includes a fatty alcohol ethoxylate C₁₂₋₁₅ 7EO (non-ionic surfactant) and sodium laureth sulfate (anionic surfactant).

As stated above, the detergent composition also includes a primary amine source. In the present disclosure, the primary amine source is a sustainable material that comprises a fermented amino acid that includes a reducing sugar. The reducing sugar can be a contaminate (residual) or it can be a moiety of the fermented amino acid that can be released upon degradation. In detergent compositions including such a primary amine source, the reducing sugar (residual or released) and the primary amine source can react together under heat to cause unwanted yellowing of the detergent composition.

In embodiments of the present disclosure, the reducing sugar is present in the fermented amino acid in an amount of from about 0.0001 weight percent to about 1 weight percent, with an amount of from about 0.005 weight percent to about 0.5 weight percent being more typical. A reducing sugar is any sugar that can act as a reducing agent. The reducing sugar can include a monosaccharide or disaccharide. Exemplary reducing sugars that can be contained in the fermented amino acid include, but are not limited to, fructose, glucose, hexose, lactose, glyceraldehyde, arabinose, maltose, galactose, ribose, xylose, cellobiose or combinations thereof. The reducing sugar can be present in the raw materials that are used in forming the fermented amino acid.

The primary amine source (i.e., fermented amino acid) is typically present in the detergent composition in an amount from about 5 weight percent to about 30 weight percent, with an amount from about 10 weight percent to about 25 weight percent being more typical, and an amount from about 12 weight percent to about 20 weight percent being even more typical.

Fermented amino acids are amino acids that are produced by breaking down protein sources with bacteria, yeast or enzymes. Typically, amino acid fermentation is a process that involves the use of microorganisms (such as, for example, probiotic bacteria) to convert plant-derived ingredients into amino acids. In embodiments of the present disclosure, the fermented amino acids that can be used as the primary amine source includes alanine, arginine, asparagine, aspartate, cysteine, glutamine, glutamate, glycine, histidine, isoleucine, lysine, methionine, phenylalanine, proline, serine, threonine, tryptophan, tyrosine, valine, or any combination thereof. In one preferred embodiment, lysine is employed as the fermented amine acid. The fermented amino acid can be in any stereoisomeric configuration, e.g., L-lysine or D-lysine can be used.

In some embodiments of the present disclosure, a secondary amine source can be used in conjunction with the primary amine source. The secondary amine source that can be employed in the present disclosure includes any compound that contains at least one amine functional group and that can be used in laundry detergent formulations. For example, the secondary amine source can include, but is not limited to, an ethanolamine compound, a chelating agent, another amino acid, an amine containing enzyme or any combination thereof.

Ethanolamine compounds contain a group of amino alcohols. Ethanolamine compounds can be used as a surfactant in some detergent compositions. Ethanolamine compounds can aid in the removal of dirt, grease and stains. Illustrative examples of ethanolamine compounds include, but are not limited to, monoethanolamine, diethanolamine, triethanolamine or mixtures thereof.

A chelating agent is a compound containing a ligand (typically organic) that can react with metal ions to form a stable, water-soluble complex. Chelating agents can also be referred to as chelants, chelators or sequestering agents. Chelating agents have a ring-like center which forms at least two bonds with the metal ion. In the present disclosure, the chelate is any compound that includes at least an amine functional and that can be used in laundry detergent formulations. Exemplary chelates that can be employed in the present disclosure as the amine source include, but are not limited to, tetrasodium iminodisuccinate, ethylenediamine, ethylenediaminetetraacetic (EDTA) or mixtures thereof.

The amino acids that can be used as the secondary amine source are typically non-fermented amino acids. The amino acids that can be used as the secondary amine source are organic compounds that contain both amino and carboxylic functional groups. Exemplary amino acids that can be used as the secondary amine source include, but are not limited to, one of the amino acids mentioned above for the fermented amine acids. The amino acid that can be used as the secondary amine source can be compositionally the same as, or compositionally different from, the fermented amine acid. The secondary amino acid can be devoid of a reducing sugar.

Amine containing enzymes (i.e., enzymes that containing at least one amine functionality) can also be used as the secondary amine source.

As mentioned above, the detergent composition of the present disclosure further includes a Maillard reaction inhibiting enzyme. In embodiments of the present disclosure, the Maillard reaction inhibiting enzyme is any enzyme that can prevent yellowing of the detergent composition by inhibiting the reaction (i.e., Maillard reaction) between the reducing sugar and the primary amine source and, if present, the secondary amine source. In embodiments of the present disclosure, the Maillard reaction inhibiting enzyme is typically present in the detergent composition in an amount of from about 0.001 weight percent to about 3 weight percent, with an amount of from about 0.005 weight percent to about 0.5 weight percent being more typical, and an amount from about 0.01 weight percent to about 0.1 weight percent being even more typical. In some embodiments, the Maillard reaction inhibiting enzyme is a reducing sugar oxidation enzyme. Such oxidation enzymes oxidize the reducing sugar that is present and prevent subsequent yellowing of the detergent composition from occurring. In some embodiments of the present disclosure, the Maillard reaction inhibiting enzyme is an enzyme that reacts with fructose and glucose. Illustrative examples of Maillard reaction inhibiting enzymes that can prevent yellowing of the detergent composition of the present disclosure include, but are not limited to, fructosamine oxidase, fructosamine kinase, or carbohydrate oxidase. It is noted that within the range mentioned above, the Maillard reaction inhibiting enzyme can prevent the Maillard reaction from occurring throughout the entire shelf-life of the detergent composition.

The detergent composition of the present disclosure further includes water. The amount of water that is present in the detergent composition can vary depending on whether the detergent composition is in unit dose form, or non-unit dose form. This will be described in greater detail herein.

In some embodiments of the present disclosure, the detergent composition of the present disclosure has a pH from 6 to 12. In other embodiments of the present disclosure, the detergent composition of the present disclosure has a pH from 6.5 to 10. In some embodiments, the pH can be selected to enhance the efficacy of the Maillard reaction inhibiting enzyme.

It is noted that reducing sugars can be contained in other raw materials that are used in formulating the detergent composition. In the present disclosure, these reducing sugars can be a residual contaminant present in the other raw materials, or it can be a moiety of the raw material that can be released upon degradation. For example, a reducing sugar can be contained in a sustainable solvent and/or sustainable polymer that can be used in formulating a detergent composition. The Maillard reaction inhibiting enzyme mentioned above will inhibit the Maillard reaction of the primary amine source and, if present, the secondary amine source, with the reducing sugars contained in these other raw materials.

In some embodiments, the detergent composition of the present disclosure can further include a sustainable polymer that includes a reducing sugar monomer. In some embodiments of the present disclosure, the sustainable polymer can be present in the detergent composition in an amount of from about 0.01 weight percent to about 10 weight percent. In other embodiments of the present disclosure, the sustainable polymer can be present in the detergent composition in an amount of from about 0.25 weight percent to about 2 weight percent. In yet other embodiments of the present disclosure, the sustainable polymer can be present in the composition in an amount of from about 0.5 weight percent to about 1 weight percent. The polymer including the reducing sugar can include a polysaccharide.

A polysaccharide is a polymer made of chains of monosaccharides that are joined by glycosidic linkages. A polysaccharide typically consists of more than ten monosaccharide units. Polysaccharides may be linear or branched. Linear polysaccharides are typically rigid polymers, while branched polysaccharides are typically soluble in water. In the present disclosure, a polysaccharide includes starches, glycogens, galactogens, cellulose and/or chitin. An illustrative example of a polysaccharide that can be used in the present disclosure as the sustainable polymer includes, but is not limited to, poly alpha-1,6-glucan.

As mentioned above, the sustainable polymer includes a reducing sugar monomer. The reducing sugar monomer can be a contaminate (residual) or it can be a moiety of the sustainable polymer that can be released upon degradation. In detergent compositions including an amine source (i.e., the primary amine source, and if present, the secondary amine source mentioned above), the reducing sugar monomer (residual or released) and the primary amine source, and if present, the secondary amine source mentioned above can react together under heat to cause unwanted yellowing of the detergent composition. In embodiments of the present disclosure, the reducing sugar monomer is present in the sustainable polymer in an amount of from about 0.0001 weight percent to about 1 weight percent, with an amount of from about 0.005 weight percent to about 0.5 weight percent being more typical.

A reducing sugar monomer is any sugar monomer that can act as a reducing agent. The reducing sugar monomer can include a monosaccharide or disaccharide. Exemplary reducing sugar monomers that can be contained in the polymer include, but are not limited to, fructose, glucose, hexose, lactose, glyceraldehyde, arabinose, maltose, galactose, ribose, xylose, cellobiose or combinations thereof. The reducing sugar monomer can be present in the raw materials that are used in forming the sustainable polymer mentioned above.

In some embodiments, the detergent composition of the present disclosure can further include at least one sustainable solvent that includes a reducing sugar (residual or moiety). In embodiments of the present disclosure, the sustainable solvent is typically present in the detergent composition in an amount of from about 0.01 weight percent to about 60 weight percent, with an amount of from about 1 weight percent to about 30 weight percent being more typical, and an amount of from about 5 weight percent to about 20 weight percent being even more typical. Illustrative sustainable solvents including a reducing sugar that can be employed in the present disclosure include, but are not limited to, sorbitol, xylitol, mannitol, lactitol, isomalt, maltitol, a hydrogenated starch hydrolysate, sucrose, stachyose, verbascose, trehalose, raffinose or combinations thereof. In embodiments of the present disclosure, the reducing sugar is present in the sustainable solvent in an amount of from about 0.0001 weight percent to about 1 weight percent, with an amount of from about 0.005 weight percent to about 0.5 weight percent being more typical. The reducing sugar can be present in the raw materials that are used in forming the at least one sustainable solvent mentioned above.

In some embodiments, the detergent composition of the present disclosure can further include both a sustainable solvent that includes a reducing sugar (residual or moiety) and a sustainable polymer that includes a reducing sugar monomer (residual or moiety).

In addition to the above-mentioned components, the detergent composition of the present disclosure can include any additional detergent component(s) that is (are) known in the art. Other optional detergent components include, for example, beaching systems, anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, and wicking agents, either alone or in combination. Any component known in the art for use in detergents may be utilized. The choice of such optional components and the working amounts is well within the skill of the artisan.

In some embodiments, the detergent composition of the present disclosure can further include well known dye transfer agents, fluorescent whitening agents, soil release polymers, rheology modifiers or any combination thereof. In some embodiments, the detergent composition of the present disclosure can also include a fatty acid that has a formula R—C(O) OH, wherein R is a C₅-C₂₁ linear or branched aliphatic group. In one example, the fatty acid is dodecanoic acid (also known as coconut fatty acid).

In some embodiments, the detergent composition of the present disclosure can further include at least one other enzyme besides the Maillard reaction inhibiting enzyme mentioned above. The at least one other enzyme can enhance the cleaning performance (including, for example, stain removal, redeposition of soil released in the washing/cleaning process, or restoration, fully or partially, the whiteness of a textile) of other components that are present in the detergent composition of the present disclosure. Exemplary enzymes other than Maillard reaction inhibiting enzymes include, but are not limited to, deoxyribonucleases (DNaeses), cellulases, proteases, lipases, cutinases, amylases, peroxidases, and/or oxidase.

The detergent composition of the present disclosure can be formulated utilizing techniques well known to those skilled in the art. The various components that provide the detergent composition of the present disclosure can be added in any order. For example, the primary amine source (e.g., fermented lysine) including a reducing sugar can be added to a reactor vessel including at least one surfactant, water and an optional secondary amine source, and thereafter a Maillard reaction inhibiting enzyme can be added to the vessel. The addition is typically a metered addition. Alternatively, a Maillard reaction inhibiting enzyme can be added to a reactor vessel including a primary amine source (e.g., fermented lysine) including a reducing sugar and an optional secondary amine source, and thereafter water and at least one surfactant can be added. The addition of the various components that provide the detergent composition of the present disclosure can be performed with continuous stirring. The addition is typically performed at room temperature, e.g., from about 20° C. to about 30° C. In some embodiments, an enzyme enhancing agent can be added during the formulation process to improve the performance of the Maillard reaction inhibiting enzyme. In some embodiments, the Maillard reaction inhibiting enzyme can be added to a previously formulated detergent composition that includes at least one surfactant, a primary amine source, as defined herein (i.e., fermented amino acid including a reducing sugar), and water that has been stored for some period of time.

In some embodiments, the detergent composition of the present disclosure is in unit dose form. In such embodiments, a detergent product is provided that includes a container and a detergent composition, as defined above, that comprises, consists essentially of, or consists of at least one surfactant, a primary amine source, as defined herein (i.e., fermented amino acid including a reducing sugar), a Maillard reaction inhibiting enzyme that inhibits reaction between the primary amine source and the reducing sugar, and water.

The container may be a pouch, a pod or a pack (or pac) made from a water-soluble or water-dispersible polymer film, which encloses the detergent composition of the present disclosure. The water-soluble or water-dispersible container can be in any desirable shape and size, e.g., square, rectangular, oval, elliptoid, super-elliptical, or circular shape. The container can contain one or more compartments.

As stated above, the container of the unit dose is formed from a water-soluble or water-dispersible polymer film. Non-limiting examples of water-soluble or water-dispersible polymers include polyvinyl alcohol, cellulose ethers, polyethylene oxide, starch, polyvinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycol, carboxymethylcellulose, polyacrylic acid salts, alginates, acrylamide copolymers, guar gum, casein, ethylene-maleic anhydride resins, polyethyleneimine, ethyl hydroxyethylcellulose, ethyl methylcellulose, hydroxyethyl methylcellulose, film forming cellulosic polymer, polyanhydride, polysaccharide, polyalkylene oxide, cellulose, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, maltodextrin, polymethacrylate, polyvinyl alcohol copolymer, and combinations thereof.

In some embodiments, the water-soluble or water-dispersible film material of the container may be polyvinyl alcohol, polyvinyl acetate, film forming cellulosic polymer, polyacrylic acid, polyacrylamide, polyanhydride, polysaccharide, or a mixture thereof. In one example, the water-soluble or water-dispersible film material is polyvinyl alcohol or polyvinyl acetate. In another example, the water-soluble or water-dispersible container is made from a lower molecular weight water-soluble polyvinyl alcohol film-forming resin.

In some embodiments, the water-soluble or water-dispersible container can further contain a cross-linking agent. In one embodiment, the cross-linking agent can be boric acid or sodium borate.

The film material on the container can have a thickness of between about 50 microns to about 120 microns, with a thickness between about 60 microns to about 100 microns being more typical.

The water-soluble or water-dispersible container of the unit dose embodiment can be prepared in any suitable way, such as via molding, casting, extruding or blowing, and is then filled using an automated filling process, as known in the prior art.

The detergent composition that can be used in the unit dose embodiment includes (i) the detergent composition of the present disclosure; and (ii) a solvent system. The solvent system can consist of water, a non-aqueous solvent (NAS), and a residual solvent present in an amount of 0 to 5 percent by weight of the liquid composition. In embodiments, the NAS can include a single NAS or more than one non-aqueous solvent can be employed. The residual solvent is neither water nor the NAS. Each of water and the NAS is present in an amount of more than 5 percent by weight of the liquid composition, with the solvent system totals from about 30% to about 80% by weight of the liquid composition.

In some embodiments, the solvent system comprises from about 37.5% to about 70%, preferably from about 40% to about 65%, and more preferably from about 50% to about 60%, based on the total weight of the detergent composition. In other embodiment, the solvent system is present in an amount of from 37.5% to about 40%, from about 40% to about 45%, from about 45% to about 50%, from about 50% to about 55%, from about 55% to about 60%, from about 60% to about 65%, from about 65% to about 70%, from about 70% to about 75%, or from about 75% to about 80%, by weight of the detergent composition.

Typically two or three non-aqueous solvents which are greater than 5% wt. are present in the liquid composition. In some embodiments, the NAS is typically present from about 10% to about 70%, more typically from about 20% to about 65%, even more typically from about 25% to about 60%, yet more typically from about 30% to about 55%, and still yet more typically from about 40% to about 55%, based on the total weight of the detergent composition.

In other embodiments, the NAS is present in an amount of from about 10% to about 20%, from 20% to about 30%, from about 30% to about 40%, from about 40% to about 50%, from about 50% to about 60%, from about 60% to about 70%, by weight of the detergent composition.

In some embodiments, the NAS is present in an amount of about 25%, from 22% to about 27%, from 28% to about 35%, from about 33% to about 43%, or from about 40% to about 45%, by weight of the detergent composition.

In some embodiments, the NAS may be chosen from ethanol; polyethylene glycol; polypropylene glycol; polypropylene glycol esters; polyethylene glycol esters such as polyethylene glycol stearate, polyethylene glycol laurate, and/or polyethylene glycol palmitate; methyl ester ethoxylate; diethylene glycol; dipropylene glycol; sorbitol; tetramethylene glycol; butylene glycol; pentanediol; hexylene glycol; heptylene glycol; octylene glycol; 2-methyl-1,3-propanediol; xylitol; mannitol; erythritol; dulcitol; inositol; adonitol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris(2-hydroxyethyl)methyl ammonium methylsulfate; ethylene oxide/propylene oxide copolymers with the non-aqueous solvent has a weight average molecular weight of 4000 Daltons or less.

In some embodiments, the NAS is selected from polyethylene glycol; polyethylene glycol esters such as polyethylene glycol stearate, polyethylene glycol laurate, and/or polyethylene glycol palmitate; polyproylene glycol.

In some embodiments, the NAS is polyethylene glycol (“PEG”) and an ester thereof. The PEG can have a weight average molecular weight ranging, for example, from about 100 to about 4000 Daltons. Suitable PEGs can have a weight average molecular weight of, for example, about 300, about 400, about 500, about 600, about 700, about 800, about 900, about 1000, about 1100, about 1200, about 1300, about 1400, about 1500, about 1600, about 1700, about 1800, about 1900, about 2000, about 2100, about 2200, about 2300, about 2400, about 2500, or about 2600, about 2700, about 2800, about 2900, about 3000, about 3500, or about 4000 Daltons.

In some embodiments, the NAS is PEG 100 stearate, PEG 400, or PEG 3350. In other embodiments, the NAS is PEG 400 in an amount of from about 20% to about 45% by weight of the liquid composition; while water is present in an amount of from about 10% to about 30% by weight of the detergent composition.

The water in the detergent composition of the unit-dose form can be derived from added water or water accompany a component that forms the raw material that is used in formulating the detergent composition. The total water amount presented in the detergent composition is typically from about 5% to about 45%, more typically from about 10% to about 40%, even more typically from about 15% to about 35%, still more typically from about 20% to about 40%, yet more typically from about 25% to about 35%, and even further typically from about 25% to about 30%, based on the total weight of the detergent composition.

In other embodiments, water is present in an amount of from about 5% to about 10%, from 10% to about 15%, from about 15% to about 20%, from about 20% to about 25%, from about 25% to about 30%, from 30% to about 35%, from about 35% to about 40%, or from about 40% to about 45%, by weight of the detergent composition.

In some embodiments, water is present in an amount of from 11% to about 16%, from 17% to about 23%, or from about 22% to about 32%, by weight of the detergent composition.

In some embodiments, the weight ratio of water to the NAS is from 1:4 to 4:1, from 1:3 to 3:1, from 1:3 to 2:1, from 1:2 to 2:1, or about 1:1. In other embodiments, the weight ratio of water to the NAS is from 1:1 to 4:1, from 1:1 to 3:1, or from 1:1 to 2:1. In further embodiments, the weight ratio of water to the NAS is about 0.5:1, about 0.8:1, about 1:1, about 1:1, about 1.2:1, about 1.3:1, or about 1.5:1.

The term “residual solvent(s)” generally refer to a solvent that is introduced into the detergent composition by the addition of an ingredient (i.e., a commercial product containing the ingredient and the residual solvent), where the residual solvent is less than 5% by weight of the detergent composition. In some embodiments, the residual solvent is less than 5% wt, or less than 3% wt, or less than 1% wt.

The residual solvent is neither water nor the NAS. In some embodiments, the residual solvent is a mono-ol or di-ol with a low Mw. For example, the residual solvent may be ethanol. The existence of the residual solvent does not interfere with the performances of the solvent system.

As mentioned above, the detergent composition is encapsulated in a container made of a water-soluble or water-dispersible film. The solubility of the polymeric film in water should be moderated to keep the film structurally sound prior to use. In some embodiments, the inclusion of a non-aqueous solvent of certain type in the detergent composition moderates the solubility of the film, thereby protecting the film from being dissolved by water incorporated in the detergent composition. As such, adding the non-aqueous solvent to the detergent composition allows for unit dose pacs where the detergent composition therein includes water present in amounts of up to about 45%, by the weight of the detergent composition. It also allows for unit dose pacs where the detergent composition therein includes contain a high total solvent content, up to about 80%, by the weight of the detergent composition without compromising pac rigidity.

In some embodiments, the detergent composition of the present disclosure is in liquid detergent (i.e., non-unit dose form). In such embodiments, the detergent composition can comprise, consist essentially of, or consist of at least one surfactant, a primary amine source, as defined herein (i.e., fermented amino acid including a reducing sugar), a Maillard reaction inhibiting enzyme that inhibits reaction between the primary amine source and the reducing sugar, and water. In such embodiments, the detergent composition can contain at least 20 percent by weight and up to 95 percent by weight water, such as up to about 70 percent by weight water, up to about 65 percent by weight water, up to about 55 percent by weight water, up to about 45 percent by weight water, up to about 35 percent by weight water. Other types of solvents, besides water including, for example, organic solvents comprising alkanols, amines, diols, ethers and/or polyols can also be included in the non-unit dose liquid detergent composition of the present disclosure. The organic solvent can be present in the liquid detergent composition of the present disclosure in an amount from about 0 percent by weight, up to, and including, 30 percent by weight.

### Exemplary Detergent Composition Formulations

### Example 1

Liquid detergent compositions were prepared by mixing the components in the amounts listed in Table 1. Notably, the detergent compositions were batched using a standard overhead mixer, target pH 7.5 to 8. Formula 1 and Formula 2 of Table 1 are identical in composition except that Formula 2 included a Maillard reaction inhibiting enzyme as described herein, while the Maillard reaction inhibiting enzyme was omitted from Formula 1. Formula 1 is a comparative example (namely CE1), while Formula 2 is an example in accordance with an embodiment of the present disclosure. In both Formulas 1 and 2, L-lysine was used as the primary amine source.

TABLE 1

| | | Wt % of | Wt % of |
|---|---|---|---|
| | Raw Material | Formula 1 | Formula 2 |
| Component | Activity | (Comparative) | (Inventive) |
| Water, demineralized | 100 | q/s to 100 | q/s to 100 |
| | | (about 39.33) | (about 38.83) |
| Citric acid | 50 | 4.5 | 4.5 |
| Sodium tetraborate | 100 | 0.5 | 0.5 |
| 5H₂O | | | |
| 50% NaOH | 50 | 2.4 | 2.4 |
| Fatty alcohol | 100 | 18 | 18 |
| ethoxylate (Laureth, | | | |
| 6 EO) | | | |
| Sodium Lauryl Sulfate | 29 | 30 | 30 |
| Maillard Reaction | 100 | 0 | 0.05 to 1 |
| Inhibiting Enzyme | | | |
| L-lysine | 50 | 0.5 | 0.5 |
| Coconut Fatty Acid, | N/A | 5.28 | 5.28 |
| Anti-redeposition | | | |
| Polymer, Chelant, | | | |
| Preservative, Aqueous | | | |
| Enzyme Solution | | | |
| (Protease, Amylase, | | | |
| Mannanase blend) | | | |

### Example 2

Liquid detergent compositions were prepared by mixing the components in the amounts listed in Table 2. Notably, the detergent compositions were batched using a standard overhead mixer, target pH 11-12. Formula 3 and Formula 4 of Table 2 are nearly identical in composition except that Formula 4 included a Maillard reaction inhibiting enzyme and L-lysine as described herein, while a Maillard reaction inhibiting enzyme and L-lysine was omitted from Formula 3. Formula 3 is a comparative example (namely CE2), while Formula 4 is an example in accordance with an embodiment of the present disclosure.

TABLE 2

| | Raw | Wt % of | |
|---|---|---|---|
| | Material | Formula 3 | Formula 4 |
| Component | Activity | (CE2) | (Inventive) |
| Water | 100% | q/s | q/s |
| Nonionic surfactant | Approx. | 17.14 | 17.14 |
| (fatty alcohol ethoxylate | 88% as a | | |
| C₁₂₋₁₅ 7EO) and Anionic | blend | | |
| surfactant (sodium laureth | | | |
| sulfate, 3EO) | | | |
| Anionic surfactant / Defoamer | 100% | 10.9 | 10.9 |
| (coconut fatty acid derived from | | | |
| palm) and sodium carbonate and | | | |
| Optical Brightener and Anti- | | | |
| Redeposition Polymer and | | | |
| Preservative | | | |
| Chelant | 34% | 1.17 | 1.17 |
| (tetrasodium iminodisuccinate) | | | |
| L-lysine | 50% | 0 | 0.5 |
| Maillard Reaction Inhibiting | 100 | 0 | 0.05 to 1 |
| Enzyme | | | |

### Example 3

Liquid detergent compositions were prepared by mixing the components in the amounts listed in Table 3, pH target of 7.7. The detergent compositions in this example are meant to be encapsulated in a polyvinyl acetate (PVA) film. Formula 5 and Formula 6 of Table 3 are identical in composition except that Formula 6 included a Maillard reaction inhibiting enzyme and L-lysine as described herein, while no Maillard reaction inhibiting enzyme or L-lysine was used in Formula 5. Thus, Formula 5 is a comparative example (namely CE3), while Formula 6 is an example in accordance with an embodiment of the present disclosure.

TABLE 3

| | Raw | Wt % of | Wt % of |
|---|---|---|---|
| | Material | Formula 5 | Formula 6 |
| COMPONENT | Activity | (CE3) | (Inventive) |
| Non-Aqueous Solvents | 100 | QS to 100 | QS to 100 |
| (Polyethylene Glycol 400, Propylene | | | |
| Glycol, Glycerin, Ethanol blend) | | | |
| Fatty Alcohol Ethoxylate (25-7) | 100 | 23.07 | 23.07 |
| Monoethanolamine | 99+ | 6.04 | 6.04 |
| Water | 100 | 6.50 | 6.50 |
| Linear Alkylbenzene Sulfonic Acid | 99 | 17.0 | 17.0 |
| Coconut Fatty Acid | 100 | 10.0 | 10.0 |
| Alcohol Ethoxy Sulfate, 3EO | 70 | 4.8 | 4.8 |
| Sodium Iminodisuccinate (Chelant) | 33 | 0.6 | 0.6 |
| Sodium Sulfite, Optical Brightener, | N/A | 1.58 | 1.58 |
| Bittering Agent | | | |
| L-lysine | 50% | 0 | 0.5 |
| Maillard Reaction Inhibiting Enzyme | 100 | 0 | 0.05 to 1 |
| Final Total | | 100 | 100 |

### Example 4

Liquid detergent compositions were prepared by mixing the components in the amounts listed in Table 4. Formula 7 is a comparative example since the formulation does not include a Maillard reaction inhibiting enzyme or L-lysine as described herein. Formula 8 and Formula 9 are both inventive since they both include a Maillard reaction inhibiting enzyme.

TABLE 4

| | Wt % of | Wt % of | Wt % of |
|---|---|---|---|
| | Formula 7 | Formula 8 | Formula 9 |
| COMPONENT | (CE3) | (Inventive) | (Inventive) |
| Glycerin | QS to 100 | QS to 100 | QS to 100 |
| Fatty Alcohol Ethoxylate (25-7) | 23.07 | 23.07 | 23.07 |
| Propylene Glycol | 8.21 | 8.21 | 8.21 |
| Polyethylene Glycol 400 | 5.8 | 9.30 | 9.30 |
| 50% Sodium Hydroxide | 0 | 1.86 | 1.86 |
| Monoethanolamine | 4.8 | 0 | 0 |
| Water | 10.5 | 9.19 | 9.19 |
| Coconut Fatty Acid | 6 | 6 | 6 |
| 70% Active Sodium laureth | 4.8 | 4.8 | 4.8 |
| sulfate, 3EO | | | |
| Linear alkylbenzene sulfonic | 17 | 0 | 0 |
| acid | | | |
| Methyl Ester Ethoxylate | 0 | 17 | 0 |
| C1810EO | | | |
| Alkyl Sulfate | 0 | 0 | 17 |
| (C12-C13-alcohol sulphate, Na | | | |
| salts) | | | |
| Sodium Sulfite, Optical | 2.08 | 2.08 | 2.08 |
| Brightener, Bittering Agent, | | | |
| Sodium Iminodisuccinate | | | |
| (Chelant) | | | |
| L-lysine | 0.5 | 0.5 | 0.5 |
| Maillard Reaction Inhibiting | 0 | 0.05 to 1 | 0.05 to 1 |
| Enzyme | | | |
| Total | | 100 | 100 |

### Example 5

Liquid detergent compositions were prepared by mixing the components in the amounts listed in Table 5. Formula 10 is a comparative example since it lacks a Maillard reaction inhibiting enzyme, while Formula 11 is inventive.

TABLE 5

| | Wt % of | Wt % of |
|---|---|---|
| | Formula 10 | Formula 11 |
| COMPONENT | (CE 4) | (Inventive) |
| Glycerin | QS to 100 | QS to 100 |
| Fatty Alcohol Ethoxylate (25-7) | 23.07 | 27.07 |
| Propylene Glycol | 8.21 | N/A |
| Polyethylene Glycol 400 | 26.3 | 24.62 |
| Sodium Sulfite, Optical | 2.08 | 2.08 |
| Brightener, Bittering Agent, | | |
| Sodium Iminodisuccinate | | |
| (Chelant) | | |
| 50% Sodium Hydroxide | 1.86 | 1.86 |
| Water | 9.19 | 9.19 |
| Coconut Fatty Acid | 6.0 | 6.0 |
| 70% Active Sodium laureth | 4.8 | 4.8 |
| sulfate, 3EO | | |
| L-lysine | 0.5 | 0.5 |
| Maillard Reaction Inhibiting | 0 | 0.05 to 1 |
| Enzyme | | |
| Total | 100 | 100 |

### Example 6

Unit dose detergent compositions were prepared by mixing the components in the amounts listed in Table 6, and liquid detergent compositions were prepared by mixing the components in the amount listed in Table 7. Notably, Formulas 12-15 were created by mixing water, lysine proxy, glucose and hexose oxidase together in a standard overhead mixture for 1 hour. Glucose was added to each batch to illustrate the inclusion of a reducing sugar in the sustainable material (i.e., lysine, which can have lot to lot variation in the % of residual glucose). The rest of the materials listed in Tables 6 and 7 were added after. If the hexose oxidase was added at the end of the batch (instead of treating the sustainable material and glucose up front), a significant benefit was not seen. Sorbitol was used as a lysine proxy for a sustainable material that is fermented from glucose. Formulas 12 and 14 are of the present disclosure, while Formulas 13 and 15 are comparative examples. Namely, Formula 13 is comparative example 5 (CE5), and Formula 15 is comparative example 6 (CE6).

TABLE 6

| | | Wt % of | Wt % of |
|---|---|---|---|
| | Active | Formula 12 | Formula 13 |
| COMPONENT | (%) | (Inventive) | (CE 5) |
| Water | 100 | 24.35 | 24.4 |
| Sustainable Material | 70 | 5.0 | 5.0 |
| (i.e., proxy for lysine) | | | |
| Glucose | 100 | 0.1 | 0.1 |
| Hexose Oxidase | 100 | 0.05 | 0 |
| Glycerin | 99 | 25 | 25 |
| Alcohol Ethoxylate | 100 | 35 | 35 |
| 25-7 | | | |
| Ethanol | 100 | 2.5 | 2.5 |
| Fatty acid | 100 | 4.0 | 4.0 |
| MEA | 100 | 1.0 | 1.0 |
| QS/additional MEA | 100 | 3.0 | 3.0 |
| Total | | 100 | 100 |

TABLE 7

| | | Wt % of | Wt % of |
|---|---|---|---|
| | Active | Formula 14 | Formula 15 |
| COMPONENT | (%) | (Inventive) | (CE 6) |
| Water | 100 | 78.35 | 78.4 |
| Sustainable Material | 70 | 2.0 | 2.0 |
| (i.e., proxy for lysine) | | | |
| Glucose | 100 | 0.1 | 0.1 |
| Hexose Oxidase | 100 | 0.05 | 0 |
| Alcohol Ethoxylate | 100 | 15 | 15 |
| 25-7 | | | |
| Fatty acid | 100 | 0.5 | 0.5 |
| MEA | 100 | 1.0 | 1.0 |
| QS/additional MEA | 50 | 3.3 | 3.3 |
| Total | | 100 | 100 |

Formulas 12-15 were placed in a stability chamber at 25° C. or 37° C. Yellow color was observed after 1 month of stability. Formula 14 (included hexose oxidase) showed a color benefit over Formula 15 (no hexose oxidase). Table 8 lists the Pantone Color Rankings for Formulas 12-13, Table 9 lists the Pantone Color Ranking for Formulas 14-15, and Table 10 lists the standard Pantone Color Rankings.

TABLE 8

| | Stability Chamber | Pantone Color |
|---|---|---|
| Formula | Temperature (° C.) | Rankings (0-10) |
| Formula 12 | 25 | 0 |
| Formula 13 | 25 | 1 |
| Formula 12 | 37 | 5 |
| Formula 13 | 37 | 10 |

TABLE 9

| | Stability Chamber | Pantone Color |
|---|---|---|
| Formula | Temperature (° C.) | Rankings (0-10) |
| Formula 14 | 25 | 0 |
| Formula 15 | 25 | 0 |
| Formula 14 | 37 | 1 |
| Formula 15 | 37 | 6 |

TABLE 10

| Ranking | Pantone Color |
|---|---|
| 0 | No yellow color |
| 1 | Pantone 1205 |
| 2 | Pantone 100 |
| 3 | Pantone 120 |
| 4 | Pantone 113 |
| 5 | Pantone 114 |
| 6 | Pantone 106 |
| 7 | Pantone 107 |
| 8 | Pantone 101 |
| 9 | Pantone 121 |
| 10 | Pantone 115 |

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A detergent product comprising:
a container made by a water-soluble or water-dispersible film; and
a detergent composition encapsulated in the container and comprising:
at least one surfactant;
a primary amine source comprising a fermented amino acid including a reducing sugar;
a Maillard reaction inhibiting enzyme that inhibits reaction between the primary amine source and the reducing sugar; and
water, wherein the water is present in the detergent composition in an amount from about 5 percent to about 45 percent.

2. The detergent product of claim 1, wherein the detergent composition further comprises a secondary amine source, wherein the secondary amine source comprises an ethanolamine compound, a chelating agent, an amino acid, a peptide, a protein or combinations thereof.

3. The detergent product of claim 1, wherein the fermented amino acid comprises alanine, arginine, asparagine, aspartate, cysteine, glutamine, glutamate, glycine, histidine, isoleucine, lysine, methionine, phenylalanine, proline, serine, threonine, tryptophan, tyrosine, valine, or any combination thereof.

4. The detergent product of claim 1, wherein the reducing sugar comprises fructose, glucose, hexose, lactose, glyceraldehyde, arabinose, maltose, galactose, ribose, xylose, cellobiose or combinations thereof.

5. The detergent product of claim 1, wherein the Maillard reaction inhibiting enzyme comprises fructosamine oxidase, fructosamine kinase, carbohydrate oxidase or combinations thereof.

6. The detergent product of claim 1, wherein the Maillard reaction inhibiting enzyme is present in the detergent composition in an amount of from about 0.001 weight percent to about 3 weight percent.

7. The detergent product of claim 1, wherein the fermented amino acid is present in the detergent composition in an amount of from about 0.01 weight percent to about 10 weight percent.

8. The detergent product of claim 1, wherein the detergent composition further comprises a sustainable solvent including a reducing sugar, a sustainable polymer including a reducing sugar or a combination thereof.

9. The detergent product of claim 8, wherein the sustainable solvent comprises sorbitol, xylitol, mannitol, lactitol, isomalt, maltitol, a hydrogenated starch hydrolysate, sucrose, stachyose, verbascose, trehalose, raffinose or combinations thereof.

10. The detergent product of claim 8, wherein the sustainable polymer comprises a starch, a glycogen, a galactogen, a cellulose, a chitin or mixtures thereof.

11. A liquid detergent composition comprising:
at least one surfactant;
a primary amine source comprising a fermented amino acid including a reducing sugar;
a Maillard reaction inhibiting enzyme that inhibits reaction between the primary amine source and the reducing sugar; and
water, wherein the water is present in the liquid detergent composition in an amount from about 20 percent to about 95 percent.

12. The liquid detergent composition of claim 11, further comprising a secondary amine source, wherein the secondary amine source comprises an ethanolamine compound, a chelating agent, an amino acid, a peptide, a protein or combinations thereof.

13. The liquid detergent composition of claim 11, wherein the fermented amino acid comprises alanine, arginine, asparagine, aspartate, cysteine, glutamine, glutamate, glycine, histidine, isoleucine, lysine, methionine, phenylalanine, proline, serine, threonine, tryptophan, tyrosine, valine, or any combination thereof.

14. The liquid detergent composition of claim 11, wherein the reducing sugar comprises fructose, glucose, hexose, lactose, glyceraldehyde, arabinose, maltose, galactose, ribose, xylose, cellobiose or combinations thereof.

15. The liquid detergent composition of claim 11, wherein the Maillard reaction inhibiting enzyme comprises fructosamine oxidase, fructosamine kinase, carbohydrate oxidase or combinations thereof.

16. The liquid detergent composition of claim 11, wherein the Maillard reaction inhibiting enzyme is present in the composition in an amount of from about 0.001 weight percent to about 3 weight percent.

17. The liquid detergent composition of claim 11, wherein the fermented amino acid is present in the composition in an amount of from about 0.01 weight percent to about 10 weight percent.

18. The liquid detergent composition of claim 11, further comprising a sustainable solvent including a reducing sugar, a sustainable polymer including a reducing sugar or a combination thereof.

19. The liquid detergent composition of claim 18, wherein the sustainable solvent comprises sorbitol, xylitol, mannitol, lactitol, isomalt, maltitol, a hydrogenated starch hydrolysate, sucrose, stachyose, verbascose, trehalose, raffinose or combinations thereof.

20. The liquid detergent composition of claim 18, the sustainable polymer comprises a starch, a glycogen, a galactogen, a cellulose, a chitin or mixtures thereof.
